(19) United States
(12) Patent Application Publication
(10) Pub. No.: US 2026/0120960 A1
(43) Pub. Date: Apr. 30, 2026

(54) SOLID ELECTROLYTIC CAPACITOR

(71) Applicant: Murata Manufacturing Co., Ltd., Nagaokakyo-shi (JP)

(72) Inventors: Sachiko YOSHINO, Nagaokakyo-shi (JP); Takeshi FURUKAWA, Nagaokakyo-shi (JP)

(21) Appl. No.: 18/990,016

(22) Filed: Dec. 20, 2024

Related U.S. Application Data
(63) Continuation of application No. PCT/JP2023/019426, filed on May 25, 2023.

(30) Foreign Application Priority Data
Jul. 6, 2022 (JP) 2022-108960

(51) Int. Cl. H01G 9/048; H01G 9/042; H01G 9/07; H01G 9/15

(52) U.S. Cl. CPC H01G 9/048; H01G 9/042; H01G 9/07; H01G 9/15

(57) ABSTRACT

A solid electrolytic capacitor that includes: a valve metal base including dielectric layers on both surfaces in a thickness direction thereof; a conductive paste layer on each of both sides of the dielectric layer relative to the valve metal base in the thickness direction, the conductive paste layer including a conductive filler; an insulating layer on each of the conductive paste layers on the side opposite from the valve metal base, the insulating layer having a via hole; an outer electrode layer on each of the insulating layers, the outer electrode layer electrically connected to the conductive paste layer through the via hole and in direct contact with a portion of the conductive filler in the conductive paste layer in the via hole when viewed in a lamination direction of the conductive paste layer, the insulating layer, and the outer electrode layer.

### CROSS REFERENCE TO RELATED APPLICATIONS

The present application is a continuation of International application No. PCT/JP2023/019426, filed May 25, 2023, which claims priority to Japanese Patent Application No. 2022-108960, filed Jul. 6, 2022, the entire contents of each of which are incorporated herein by reference.

### TECHNICAL FIELD

The present disclosure relates to a solid electrolytic capacitor.

### BACKGROUND ART

For example, as described in Patent Document 1, a solid electrolytic capacitor generally includes a capacitor element and a lead frame. The capacitor element in the solid electrolytic capacitor of the Patent Document 1 includes a first electrode that is an anode and a second electrode that is a cathode. A corresponding lead terminal (lead frame) is electrically connected to each of the first electrode and the second electrode.

In Patent Document 1, the first electrode includes a valve metal as a conductive material. A dielectric layer is formed on a surface of the first electrode. The second electrode includes a solid electrolyte layer, a carbon layer, and a metal paste layer (conductive paste layer). The solid electrolyte layer covers the dielectric layer of the first electrode. The carbon layer and the conductive paste layer are laminated on the solid electrolyte layer in this order. The carbon layer includes a flaky carbon filler, a spherical carbon filler, and a binder resin. The conductive paste layer includes a metal filler and a binder resin. The conductive paste layer is typically a silver paste layer.
Patent Document 1: International Publication No. WO2021/172272

### SUMMARY OF THE DISCLOSURE

In the solid electrolytic capacitor of Patent Document 1, the second electrode, which is a cathode, is electrically connected to the lead frame with a bonding layer interposed therebetween. That is, the bonding layer including a thermosetting resin is interposed between the metal filler in the conductive paste layer positioned in an outermost surface of the second electrode and the lead frame serving as an outer electrode layer. The binder resin in the conductive paste layer is also interposed between the metal filler and the outer electrode layer. The resins interrupt the current between the metal filler and the outer electrode layer. Thus, there arises a problem that the resistance (equivalent series resistance (ESR)) of the solid electrolytic capacitor is increased when a current path in a lamination direction of the conductive paste layer and the outer electrode layer exists.

The present disclosure addresses challenges to provide a solid electrolytic capacitor that can achieve resistance reduction as for a current path in a lamination direction of a conductive paste layer and an outer electrode layer.

A solid electrolytic capacitor according to the present disclosure includes: a valve metal base having first surface and a second surface opposite to each other in a thickness direction of the valve metal base; a first dielectric layer on the first surface of the valve metal base; a second dielectric layer on the second surface of the valve metal base; a first conductive paste layer on the first dielectric layer and including a first conductive filler; a second conductive paste layer on the second dielectric layer and including a second conductive filler; a first insulating layer on the first conductive paste layer and having a first via hole; a second insulating layer on the second conductive paste layer and having a second via hole; a first outer electrode layer on the first insulating layer and electrically connected to the first conductive paste layer through the first via hole, wherein the first outer electrode layer is in direct contact with a portion of the first conductive filler in the first conductive paste layer in the first via hole when viewed in a first lamination direction of the first conductive paste layer, the first insulating layer, and the first outer electrode layer; and a second outer electrode layer on the second insulating layer and electrically connected to the second conductive paste layer through the second via hole, wherein the second outer electrode layer is in direct contact with a portion of the second conductive filler in the second conductive paste layer in the second via hole when viewed in a second lamination direction of the second conductive paste layer, the second insulating layer, and the second outer electrode layer.

With the solid electrolytic capacitor according to the present disclosure, resistance reduction as for a current path in the lamination direction of the conductive paste layer and the outer electrode layer can be achieved.

### BRIEF DESCRIPTION OF THE DRAWINGS

FIG. 1 is a sectional view illustrating the outline configuration of a solid electrolytic capacitor according to a first embodiment.

FIG. 2 is a partial enlarged view of the solid electrolytic capacitor illustrated in FIG. 1.

FIG. 3 is a partial sectional view illustrating the outline configuration of a solid electrolytic capacitor according to a second embodiment.

FIG. 4 is a schematic view illustrating one example of a conductive filler in a sectional SEM image of the solid electrolytic capacitor illustrated in FIG. 3.

FIG. 5 is a partial sectional view illustrating the outline configuration of a solid electrolytic capacitor according to a modification of the second embodiment.

FIG. 6 is a partial sectional view illustrating the outline configuration of a solid electrolytic capacitor according to a third embodiment.

FIG. 7 is a partial sectional view illustrating the outline configuration of a solid electrolytic capacitor according to a modification of the third embodiment.

### DESCRIPTION OF THE PREFERRED EMBODIMENTS

A solid electrolytic capacitor according to an embodiment includes a valve metal base, a conductive paste layer, an insulating layer, and an outer electrode layer. The valve metal base includes dielectric layers in both surfaces, in a thickness direction, of the valve metal base. The conductive paste layer is disposed on each of both sides relative to the valve metal base in the thickness direction. The conductive paste layer includes a conductive filler. The insulating layer is laminated on each of the conductive paste layers on the side opposite from the valve metal base. The insulating layer has a via hole. The outer electrode layer is laminated on each of the insulating layers. The outer electrode layer is electrically connected to the conductive paste layer through the via hole. The outer electrode layer is in direct contact with a portion, of the conductive filler included in the conductive paste layer, positioned in the via hole when viewed in a lamination direction of the conductive paste layer, the insulating layer, and the outer electrode layer (a first configuration).

In the solid electrolytic capacitor according to the first configuration, the outer electrode layer is in direct contact with the portion, of the conductive filler included in the conductive paste layer, positioned in the via hole in plan view. That is, no resin or other materials are interposed between the portion of the conductive filler at the position of the via hole and the outer electrode layer. Thus, a continuous current path can be formed between the conductive filler and the outer electrode layer. Therefore, resistance reduction as for the current path in the lamination direction of the conductive paste layer and the outer electrode layer can be achieved, and the equivalent series resistance (ESR) of the solid electrolytic capacitor can be reduced.

The outer electrode layer may include an outer electrode layer body. The outer electrode layer body is formed on a surface of the insulating layer on the side opposite from the conductive paste layer. The conductive paste layer can include, as a main conductive filler, a filler having a core material including, as a main component, the same metal as the main component of the outer electrode layer body (a second configuration).

When the conductive paste layer and the outer electrode layer body are made of different kinds of metal materials, electromigration in which metal ions move between the conductive paste layer and the outer electrode layer body occurs, which may lead to connection failure. In contrast, in the second configuration, the main component of the core material of the main conductive filler of the conductive paste layer is the same metal as the main component of the outer electrode layer body. Thus, electromigration can be suppressed, and connection stability between the conductive paste layer and the outer electrode layer can be ensured.

The main component of the outer electrode layer body may be copper. In this case, the main conductive filler is preferably a filler whose core material includes copper as a main component (a third configuration).

The outer electrode layer can further include a via conductor. The via conductor is provided in the via hole. The main component of the via conductor may be the same metal as the main component of the core material of the main conductive filler (a fourth configuration).

In the fourth configuration, in addition to the outer electrode layer body, the main component of the via conductor is the same metal as the core material of the main conductive filler of the conductive paste layer. Thus, electromigration can be further suppressed, and connection stability between the conductive paste layer and the outer electrode layer can be improved.

The main component of the outer electrode layer body and the main component of the via conductor may be both copper. In this case, the main conductive filler is preferably a filler whose core material includes copper as a main component (a fifth configuration).

In a sectional view of the solid electrolytic capacitor, the filling rate of the conductive filler relative to a length of the conductive paste layer in the lamination direction may be 50% or more (a sixth configuration).

In the sixth configuration, the filling rate of the conductive filler relative to the length of the conductive paste layer in the lamination direction of the conductive paste layer and the outer electrode layer is 50% or more. That is, the conductive paste layer is sufficiently filled with the conductive filler in a layer thickness direction thereof. Thus, resistance can be reduced relative to the current passing in the layer thickness direction of the conductive paste layer.

The conductive filler can include a first conductive filler. Particles of the first conductive filler have, for example, a crushed shape (a seventh configuration).

In the seventh configuration, the first conductive filler is included in the conductive paste layer. Since having a crushed shape, the particles of the first conductive filler are likely to overlap one another compared with a conductive filler whose particles have, for example, a spherical shape. Due to such overlapping of the first conductive filler, a continuous current path can be formed in the layer thickness direction of the conductive paste layer. Consequently, resistance can be reduced relative to the current passing in the layer thickness direction of the conductive paste layer.

The particles of the first conductive filler may have, for example, a flat shape (an eighth configuration).

In the eighth configuration, the particles of the first conductive filler are each flattened. The particles of the first conductive filler here have a smooth surface with less sharp edges compared with, for example, the case of the crushed shape. Thus, a crack starting from a sharp edge of the conductive filler can be suppressed from occurring in the conductive paste layer. Accordingly, the mechanical strength of the conductive paste layer can be improved.

The conductive filler may further include a second conductive filler. The second conductive filler can have an average particle diameter smaller than the average particle diameter of the first conductive filler (a ninth configuration).

In the ninth configuration, the conductive paste layer includes the second conductive filler in addition to the first conductive filler. The average particle diameter of the second conductive filler is smaller than the average particle diameter of the first conductive filler. Thus, particles of the second conductive filler can enter spaces between particles of the first conductive filler. Accordingly, a continuous current path is further easily formed in the layer thickness direction of the conductive paste layer, and resistance can be further reduced relative to the current passing in the layer thickness direction of the conductive paste layer.

Hereinafter, embodiments of the present disclosure will be described with reference to the drawings. The same or corresponding constituents in the drawings are denoted by the same reference signs, and redundant description is not repeated.

### First Embodiment

### [Configuration of Solid Electrolytic Capacitor]

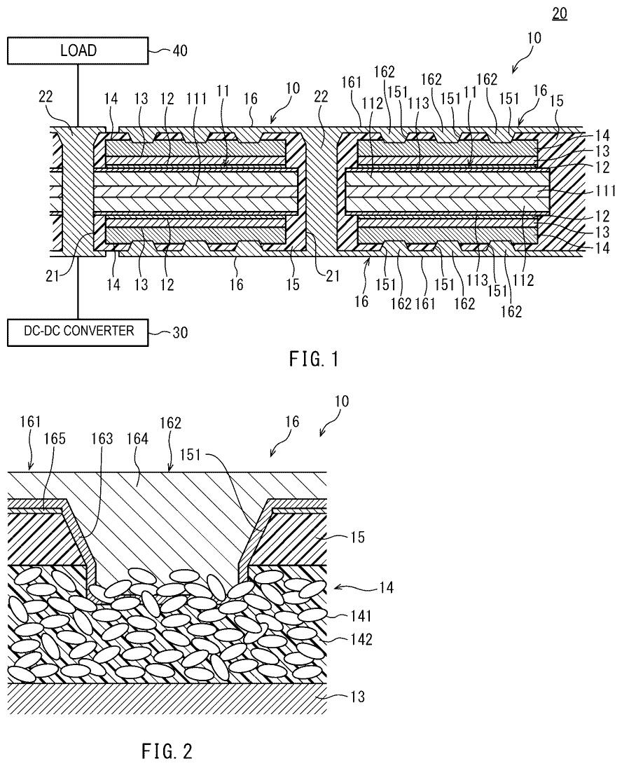

FIG. 1 is a sectional view illustrating the outline configuration of a solid electrolytic capacitor 10 according to a first embodiment. As FIG. 1 illustrates, the solid electrolytic capacitor 10 is included in, for example, a multilayer substrate (package substrate) 20 such as a component built-in substrate. FIG. 1 partially and schematically illustrates a section of the package substrate 20.

For example, a DC-DC converter 30 and a load 40 that is an integrated circuit (IC) are mounted on the package substrate 20. The DC-DC converter 30 is disposed on a surface of the package substrate 20 on one side in a thickness direction of the package substrate 20. The load 40 is disposed on a surface of the package substrate 20 on the side opposite from the DC-DC converter 30 in the thickness direction of the package substrate 20. In the example of the present embodiment, the package substrate 20 includes multiple solid electrolytic capacitors 10. The solid electrolytic capacitors 10 may be arranged in an array in the package substrate 20.

Referring to FIG. 1, each of the solid electrolytic capacitors 10 includes a valve metal base 11, a solid electrolyte layer 12, a carbon layer 13, a conductive paste layer 14, an insulating layer 15, and an outer electrode layer 16.

The valve metal base 11 has a plate shape or a foil shape. The valve metal base 11 functions as an anode of the solid electrolytic capacitor 10. The valve metal base 11 includes a core layer 111, porous layers 112, and dielectric layers 113. The valve metal base 11 includes the dielectric layers 113 in both surfaces, in a thickness direction, of the valve metal base 11.

The core layer 111 is a layer made of a valve metal. Examples of the valve metal include metal simple substances such as aluminum, tantalum, niobium, titanium, and zirconium and an alloy including at least one kind of these metals. The valve metal is preferably aluminum or an aluminum alloy.

The porous layers 112 and the dielectric layers 113 are provided on both surfaces of the core layer 111 so as to sandwich the core layer 111 from both sides in a thickness direction of the core layer 111. The porous layer 112 and the dielectric layer 113 are laminated, in this order, on each of the surfaces, in the thickness direction, of the core layer 111. For example, the porous layer 112 can be formed on the surface of the core layer 111 by performing an etching treatment on a surface of a valve metal plate or a valve metal foil. Moreover, the dielectric layer 113 constituted by a film of oxide can be formed on the porous layer 112 by performing an anodic oxidation treatment (chemical conversion treatment).

In the example illustrated in FIG. 1, the package substrate 20 has multiple through holes 21. A through hole conductor 22 is provided in each of the through holes 21. The core layer 111 of the valve metal base 11 may be directly connected to the through hole conductor 22 with an inner wall surface of the through hole 21 interposed therebetween.

The through hole conductor 22 is constituted by a conductive material. The through hole conductor 22 is formed at least on the inner wall surface of the through hole 21. For example, the through hole conductor 22 can be formed by metallizing the inner wall surface of the through hole 21 with a material including, for example, a metal such as copper, gold, or silver or an alloy thereof as a main component. Alternatively, the through hole conductor 22 may be formed by filling the through hole 21 with a conductive material.

The solid electrolyte layer 12, the carbon layer 13, and the conductive paste layer 14 are disposed on each of both sides, in the thickness direction, of the valve metal base 11. That is, the solid electrolyte layer 12, the carbon layer 13, and the conductive paste layer 14 are laminated, in this order, on each of the surfaces, in the thickness direction, of the valve metal base 11. The solid electrolyte layer 12, the carbon layer 13, and the conductive paste layer 14 function as a cathode of the solid electrolytic capacitor 10.

The solid electrolyte layer 12 is disposed on the dielectric layer 113 of the valve metal base 11. The solid electrolyte layer 12 preferably covers the entire surface of the dielectric layer 113 on the side opposite from the core layer 111 and the porous layer 112. The solid electrolyte layer 12 is typically formed by a conductive polymeric material. Examples of a conductive polymer include polypyrroles, polythiophenes, and polyanilines. The conductive polymer is preferably a polythiophene, particularly preferably poly(3,4-ethylenedioxythiophene) referred to as PEDOT. The conductive polymeric material may be a material in which, for example, polystyrene sulfonate (PSS) is used as a dopant.

The carbon layer 13 is disposed on the solid electrolyte layer 12. The carbon layer 13 preferably covers the entire surface of the solid electrolyte layer 12 on the side opposite from the valve metal base 11. The carbon layer 13 includes, for example, a carbon filler and a binder. For example, the carbon layer 13 can be formed by applying a carbon paste including a carbon filler and a binder in a fluidized state onto the solid electrolyte layer 12 by, for example, sponge transfer, screen printing, spraying, the use of a dispenser, or inkjet printing.

The conductive paste layer 14 is disposed on the carbon layer 13. The conductive paste layer 14 preferably covers the entire surface of the carbon layer 13 on the side opposite from the solid electrolyte layer 12. The conductive paste layer 14 is connected to the solid electrolyte layer 12 by the carbon layer 13.

The insulating layer 15 is laminated on the conductive paste layer 14 on the side opposite from the valve metal base 11. The insulating layer 15 preferably covers the entire surface of the conductive paste layer 14 on the side opposite from the valve metal base 11. The insulating layer 15 may be shared by multiple solid electrolytic capacitors 10. That is, the insulating layer 15 may extend throughout such multiple solid electrolytic capacitors 10 so as to mask the multiple solid electrolytic capacitors 10. In this case, the area of the conductive paste layers 14 is smaller than the effective capacitance portion of the solid electrolytic capacitors 10 separated into a group by the insulating layer 15.

The insulating layer 15 is typically formed by a resin. The insulating layer 15 can be formed by, for example, a thermosetting resin. The insulating layer 15 is preferably formed by an epoxy-based resin material. Examples of an epoxy-based resin include a phenol-curable epoxy resin, a cyanate ester/epoxy mixture resin, and a phenol ester-curable epoxy resin.

The insulating layer 15 has at least one via hole 151. In the example of the present embodiment, the insulating layer 15 has multiple via holes 151. Each of the via holes 151 passes through the insulating layer 15 in the lamination direction of the valve metal base 11, the solid electrolyte layer 12, the carbon layer 13, the conductive paste layer 14, and the insulating layer 15. The via hole 151 can be formed by irradiating the insulating layer 15 with a laser from a laser machining apparatus. The laser at this time is, for example, a CO₂ laser.

The via hole 151 is formed into, for example, a tapered shape whose width decreases toward the conductive paste layer 14 in a sectional view of the solid electrolytic capacitor 10. However, the width of the via hole 151 may be uniform throughout the via hole 151 in the sectional view of the solid electrolytic capacitor 10. A cross section of the via hole 151, that is, a section perpendicular to the central axis of the via hole 151 has, for example, a circular shape.

The outer electrode layer 16 is provided on the insulating layer 15. The outer electrode layer 16 is electrically connected to the conductive paste layer 14 through the via hole 151. The outer electrode layer 16 includes an outer electrode layer body 161 and a via conductor 162.

The outer electrode layer body 161 is formed on a surface of the insulating layer 15 on the side opposite from the conductive paste layer 14. The outer electrode layer body 161 can function as a wiring layer.

The outer electrode layer body 161 may extend to any one of the through hole conductors 22 from the solid electrolytic capacitor 10. Any one of the outer electrode layer bodies 161 disposed on both sides, in a thickness direction, of the solid electrolytic capacitor 10 may be electrically connected to the through hole conductor 22 connected to a GND.

The via conductor 162 is provided in the via hole 151. The via conductor 162 electrically connects the outer electrode layer body 161 to the conductive paste layer 14.

FIG. 2 illustrates, while enlarging, the via hole 151 and part therearound in the section of the solid electrolytic capacitor 10 illustrated in FIG. 1. Hereinafter, in particular, the configurations of the conductive paste layer 14 and the outer electrode layer 16 will be described in more detail with reference to FIG. 2.

As FIG. 2 illustrates, the conductive paste layer 14 includes a conductive filler 141 and a binder 142.

The conductive filler 141 has electrical conductivity. The conductive filler 141 may be a metal filler or a nonmetal filler. Each particle of the conductive filler 141 includes a core material. Each particle of the conductive filler 141 may include a coating layer covering the core material. When the conductive filler 141 is a metal filler, the main component of the core material of the conductive filler 141 may be a metal such as copper, nickel, or silver. The main component of the core material of the conductive filler 141 means an element having the highest content (for example, mass %) in the chemical composition of the core material.

The conductive paste layer 14 preferably includes, as the main conductive filler 141, a filler whose core material includes copper as a main component. More specifically, a metal filler including a copper particle or a copper alloy particle as a core material preferably exists in the conductive paste layer 14 as the main conductive filler 141.

The conductive filler 141 included in the conductive paste layer 14 may be fully constituted by a filler made of the same kind of material. The conductive paste layer 14 may include the conductive fillers 141 constituted by different kinds of materials in a mixed manner. For example, the conductive paste layer 14 may include only a copper filler including a copper particle or a copper alloy particle as a core material or may include such a copper filler and a silver filler including a silver particle or a silver alloy particle as a core material in a mixed manner. When the conductive paste layer 14 includes fillers of different kinds of materials in a mixed manner, the main conductive filler 141 is a filler having the highest content rate in the conductive paste layer 14. When the filler in the conductive paste layer 14 is fully constituted by a filler made of the same kind, the filler is the main conductive filler 141.

The main conductive filler 141 of the conductive paste layer 14 can be identified by using, for example, a sectional SEM image of the solid electrolytic capacitor 10. Specifically, a sectional SEM image is obtained at any position of the solid electrolytic capacitor 10, and the sectional SEM image is subjected to required image processing so as to be brought to a state where the conductive filler 141 and the binder 142 can be distinguished. In addition, when the conductive paste layer 14 includes the conductive fillers 141 constituted by different kinds of materials in a mixed manner, the sectional SEM image is brought to a state where the conductive fillers 141 can be distinguished by the materials. Then, from the sectional SEM image after the image processing, the ratio of the area of each of the fillers to the area of the conductive paste layer 14 is calculated as a content rate (vol %), and the filler having the highest content rate in the sectional SEM image can be determined as the main conductive filler 141. The content rate of the entire conductive filler 141 in the conductive paste layer 14 is, for example, 30 vol % to 80 vol %. Depending on the content rate of the entire conductive filler 141, the content rate of the main conductive filler 141 in the conductive paste layer 14 is preferably 50 vol % or more.

The binder 142 contains the conductive filler 141. That is, a large number of particles of the conductive filler 141 are scattered in the binder 142. At least a portion of the conductive filler 141 positioned in the via hole 151, when viewed in the lamination direction of the conductive paste layer 14 and the insulating layer 15, and existing in an outermost layer of the conductive paste layer 14 is exposed at the binder 142. More specifically, in a region of the conductive paste layer 14 positioned in the via hole 151 when viewed in the lamination direction, a portion of the binder 142 in the outermost layer has been fired and disappeared by being irradiated with a laser when the via hole 151 is formed in the insulating layer 15. Thus, in the region, the portion of the conductive filler 141 is exposed at the binder 142. On the other hand, a portion of the conductive filler 141 positioned in an outer region relative to the via hole 151 when viewed in the lamination direction is covered with the binder 142 and the insulating layer 15.

In a sectional view of the solid electrolytic capacitor 10, the filling rate of the conductive filler 141 relative to a length (layer thickness) of the conductive paste layer 14 in the lamination direction is preferably 50% or more. The filling rate of the conductive filler 141 can be measured by using a sectional image of the solid electrolytic capacitor 10. For example, in a sectional SEM image obtained at any position of the solid electrolytic capacitor 10, a layer thickness L0 of the conductive paste layer 14 is measured at each of 10 spots spaced uniformly, lengths L1 of the particles of the conductive filler 141 in the layer thickness direction at the same spot are measured, and a sum S_{L1} of L1 is calculated. The average of the results from S_{L1}/L0×100 at the 10 spots is then calculated, and the average can be referred to as the filling rate (%) of the conductive filler 141 in the layer thickness direction of the conductive paste layer 14.

The conductive paste layer 14 can be formed by applying a conductive paste including the conductive filler 141 and the binder 142 in a fluidized state onto the carbon layer 13. The conductive paste is applied onto the carbon layer 13 by, for example, sponge transfer, screen printing, spraying, the use of a dispenser, or inkjet printing. The applied conductive paste is formed into the conductive paste layer 14 by, for example, causing the binder 142 to set through firing.

Still referring to FIG. 2, the outer electrode layer 16 is electrically connected to the conductive paste layer 14 by the via conductor 162. The via conductor 162 includes an electroless plating layer 163 and an electrolytic plating layer 164.

The electroless plating layer 163 is provided directly on a side wall of the via hole 151. The electroless plating layer 163 is a film of a metal deposited by chemical reaction. In the example illustrated in FIG. 2, the electroless plating layer 163 extends to a surface, of the insulating layer 15, in an outer region relative to the via hole 151. That is, the electroless plating layer 163 constitutes, in addition to a portion of the via conductor 162, a portion of the outer electrode layer body 161 that is the wiring layer. In the outer electrode layer body 161, a seed layer 165 may be provided between the electroless plating layer 163 and the insulating layer 15. The seed layer 165 can be formed by, for example, forming a metal film on the insulating layer 15 by an electrolytic plating treatment or an electroless plating treatment and then by removing a portion of the metal film by photolithoetching.

The electrolytic plating layer 164 is provided on the electroless plating layer 163. The electrolytic plating layer 164 covers the entire electroless plating layer 163. The electrolytic plating layer 164 is a film of a metal deposited by using electricity.

In the example illustrated in FIG. 2, a so-called filled via is used for connection between the conductive paste layer 14 and the outer electrode layer 16, and the via hole 151 is filled with the via conductor 162. However, the via conductor 162 may be formed so as to be recessed along the via hole 151. That is, a so-called conformal via may connect the conductive paste layer 14 and the outer electrode layer 16 to each other.

The outer electrode layer 16 is in direct contact with a portion, of the conductive filler 141 included in the conductive paste layer 14, positioned in the via hole 151 when viewed in the lamination direction of the conductive paste layer 14 and the insulating layer 15. More specifically, in a region of the conductive paste layer 14 positioned in the via hole 151 in a plan view of the solid electrolytic capacitor 10, a portion of the conductive filler 141 is exposed at the binder 142. Thus, the via conductor 162 of the outer electrode layer 16 can be in direct contact with the portion of the conductive filler 141 exposed at the binder 142. The via conductor 162 may be joined to the conductive filler 141.

When the main conductive filler 141 in the conductive paste layer 14 is a metal filler, the main component of the outer electrode layer body 161 is preferably the same metal as the main component of the core material of the main conductive filler 141. For example, when the core material of the main conductive filler 141 is one metal or an alloy of the metal, the outer electrode layer body 161 is preferably also formed by the metal or the alloy of the metal. More preferably, the main conductive filler 141 is a filler whose core material includes copper as a main component, and the main component of the outer electrode layer body 161 is copper.

The main component of the via conductor 162 is preferably also the same metal as the main component of the core material of the main conductive filler 141. For example, when the core material of the main conductive filler 141 is one metal or an alloy of the metal, the via conductor 162 is preferably also formed by the metal or the alloy of the metal. More preferably, the main conductive filler 141 is a filler whose core material includes copper as a main component, and the main components of the outer electrode layer body 161 and the via conductor 162 are both copper. In each of the outer electrode layer body 161 and the via conductor 162, a main component means an element having the highest content (for example, mass %) in the chemical composition thereof.

When the core material of the main conductive filler 141 is a copper particle or a copper alloy particle, for example, the electroless plating layer 163 can be an electroless copper plating layer, and the electrolytic plating layer 164 can be an electrolytic copper plating layer. In addition, in this case, the seed layer 165 can be formed by copper or a copper alloy.

### Advantageous Effects

In the solid electrolytic capacitor 10 according to the present embodiment, the outer electrode layer 16 is in direct contact with the portion, of the conductive filler 141 included in the conductive paste layer 14, positioned in the via hole 151 in plan view. More specifically, inside the via hole 151, the via conductor 162 of the outer electrode layer 16 is in direct contact with the portion of the conductive filler 141 exposed at the binder 142. No interface between a conductive body of, for example, a metal and an insulating body of, for example, a resin exists in the current path from the conductive paste layer 14 to the outer electrode layer 16. That is, electricity is led from the conductive paste layer 14 to the outer electrode layer 16 by the metal-to-metal contact between the conductive filler 141 and the outer electrode layer 16, not with a contact point (interface) between the conductive filler 141 and the insulating body interposed therebetween. Thus, resistance when the current path in the lamination direction of the conductive paste layer 14 and the outer electrode layer 16 exists is reduced, and the equivalent series resistance (ESR) of the solid electrolytic capacitor 10 can be reduced.

However, the conductive paste layer 14 is electrically connected to the carbon layer 13 with a contact point (interface) between the conductive filler 141 and, for example, the binder 142 interposed therebetween. That is, the connection method of the conductive paste layer 14 relative to the carbon layer 13 differs from the connection method of the conductive paste layer 14 relative to the outer electrode layer 16.

In the present embodiment, the core material of the main conductive filler 141 of the conductive paste layer 14 preferably includes, as a main component, the same metal as the main component of the outer electrode layer body 161. The main component of the core material of the main conductive filler 141 is preferably also the same metal as the main component of the via conductor 162. For example, the main component of the core material of the main conductive filler 141 is copper, and the main components of the outer electrode layer body 161 and the via conductor 162 are both copper. In this case, electromigration between the conductive paste layer 14 and the outer electrode layer 16 can be suppressed, and connection stability between the conductive paste layer 14 and the outer electrode layer 16 can be ensured.

The filling rate of the conductive filler 141 relative to the length of the conductive paste layer 14 in the lamination direction of the conductive paste layer 14 and the outer electrode layer 16 is preferably 50% or more. In this case, the conductive paste layer 14 is sufficiently filled with the conductive filler 141 in the lamination direction of the conductive paste layer 14 and the outer electrode layer 16, that is, a direction of a current path of the solid electrolytic capacitor 10. Thus, the solid electrolytic capacitor 10 can be further reduced in ESR.

### Second Embodiment

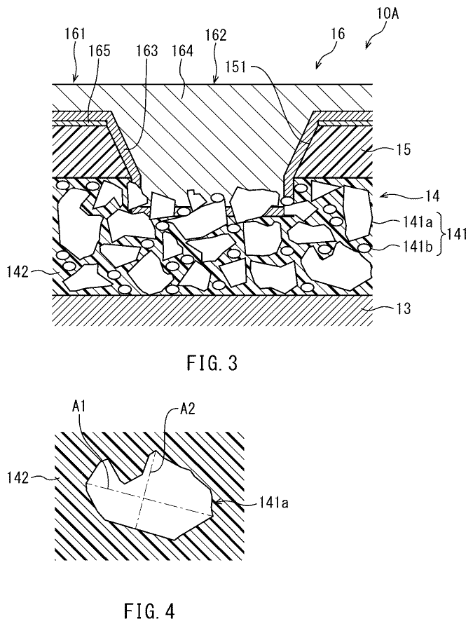

FIG. 3 is a partial sectional view illustrating the outline configuration of a solid electrolytic capacitor 10A according to a second embodiment. The solid electrolytic capacitor 10A differs from the solid electrolytic capacitor 10 according to the first embodiment only in the shape of particles of a conductive filler 141 included in a conductive paste layer 14. FIG. 3 illustrates, while enlarging, the conductive paste layer 14 and the vicinity thereof in the solid electrolytic capacitor 10A.

Referring to FIG. 3, the conductive filler 141 includes a first conductive filler 141a and a second conductive filler 141b. In the example illustrated in FIG. 3, the conductive filler 141 is constituted by the first conductive filler 141a and the second conductive filler 141b.

Particles of the first conductive filler 141a each have a crushed shape. The expression “a particle of the first conductive filler 141a has a crushed shape” means that a surface of the particle of the first conductive filler 141a has a fracture surface. Each particle of the first conductive filler 141a has, for example, five or more sharp edges in a sectional view of the solid electrolytic capacitor 10A. Particles of the second conductive filler 141b each have, for example, a substantially or approximately spherical shape. A surface of each particle of the second conductive filler 141b has no fracture surface. Each particle of the second conductive filler 141b preferably has no sharp edge in a sectional view of the solid electrolytic capacitor 10A. A particle of the second conductive filler 141b may have a sharp edge, but each particle of the second conductive filler 141b has four or less sharp edges. The second conductive filler 141b has a relatively small particle diameter.

In a sectional view of the solid electrolytic capacitor 10A, the conductive fillers 141a and 141b each have an aspect ratio of less than 4.0. The aspect ratio of each of the conductive fillers 141a and 141b can be obtained by dividing the length of the major axis of a particle thereof by the length of the minor axis of the particle thereof.

The major axis and the minor axis of each of the conductive fillers 141a and 141b can be defined as follows. FIG. 4 is a schematic view illustrating one example of the first conductive filler 141a in a sectional SEM image obtained at any position of the solid electrolytic capacitor 10A. Referring to FIG. 4, in the sectional SEM image, a major axis A1 of the first conductive filler 141a is the longest line of the lines connecting any two points in the interface of a particle of the first conductive filler 141a relative to a binder 142. In the sectional SEM image, a minor axis A2 of the first conductive filler 141a is the longest line of the lines perpendicular to the major axis A1 and connecting any two points in the interface of the particle of the first conductive filler 141a. The aspect ratio of the first conductive filler 141a can be obtained by length of major axis A1/length of minor axis A2. Although illustration is omitted, the aspect ratio of the second conductive filler 141b can also be obtained by determining the major axis and the minor axis by a method similar to that of the first conductive filler 141a. In the sectional SEM image, the conductive fillers 141a and 141b can be distinguished from each other by identifying the conductive filler 141 having a fracture surface as the first conductive filler 141a and identifying the conductive filler 141 having no fracture surface as the second conductive filler 141b.

The particle diameter of each of the conductive fillers 141a and 141b can be the length of the major axis determined as described above. The average particle diameter of the first conductive filler 141a can be obtained by averaging the particle diameters of the particles of the first conductive filler 141a included in a sectional SEM image of the solid electrolytic capacitor 10A. Similarly, the average particle diameter of the second conductive filler 141b can be obtained by averaging the particle diameters of the particles of the second conductive filler 141b included in the sectional SEM image. The average particle diameter of the first conductive filler 141a is 0.2 times or more and less than 1.0 time the maximum layer thickness of the conductive paste layer 14 obtained from the same sectional SEM image. The average particle diameter of the second conductive filler 141b is 0.1 times or more and less than 0.5 times the maximum layer thickness of the conductive paste layer 14. The average particle diameter of the second conductive filler 141b is smaller than the average particle diameter of the first conductive filler 141a. The average particle diameter of the second conductive filler 141b is, for example, 50% or less of the average particle diameter of the first conductive filler 141a, preferably 40% or less.

The main component of the core material of the first conductive filler 141a may be the same as or different from the main component of the core material of the second conductive filler 141b. In addition, in the conductive paste layer 14, the core material of the entire first conductive filler 141a may be mainly constituted by the same component, or the first conductive fillers 141a whose core materials differ in main component may exist in a mixed manner. Similarly, in the conductive paste layer 14, the core material of the entire second conductive filler 141b may be mainly constituted by the same component, or the second conductive fillers 141b whose core materials differ in main component may exist in a mixed manner.

Since having a configuration similar to the configuration of the solid electrolytic capacitor 10 according to the first embodiment, the solid electrolytic capacitor 10A according to the present embodiment can also exhibit the same advantageous effects as those of the solid electrolytic capacitor 10 according to the first embodiment. In addition, in the solid electrolytic capacitor 10A according to the present embodiment, the first conductive filler 141a whose particles have a crushed shape is included in the conductive paste layer 14. The particles of the first conductive filler 141a are likely to overlap one another compared with a conductive filler having, for example, a spherical shape, and a continuous current path can easily be formed in the layer thickness direction of the conductive paste layer 14. Thus, resistance relative to the current passing in the layer thickness direction of the conductive paste layer 14 can be reduced.

In the present embodiment, the conductive paste layer 14 includes the second conductive filler 141b in addition to the first conductive filler 141a. Since the second conductive filler 141b has an average particle diameter smaller than that of the first conductive filler 141a, particles of the second conductive filler 141b can enter spaces between particles of the first conductive filler 141a. Thus, a continuous current path is further easily formed in the layer thickness direction of the conductive paste layer 14, and resistance of the conductive paste layer 14 can be further reduced.

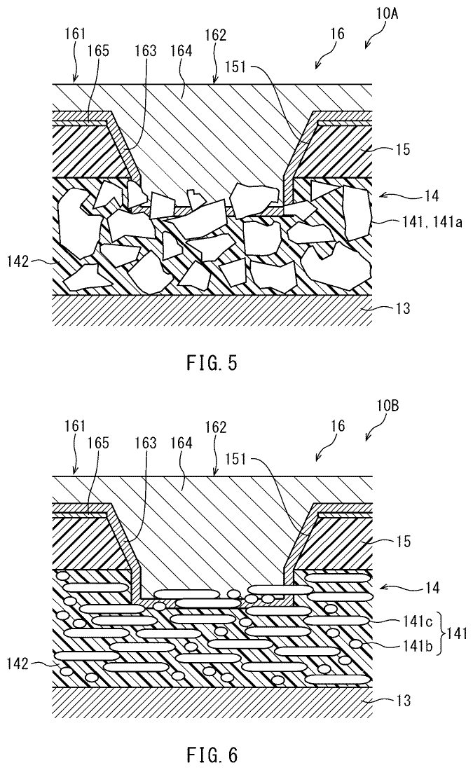

In the example illustrated in FIG. 3, the conductive paste layer 14 includes the first conductive filler 141a and the second conductive filler 141b. However, as FIG. 5 illustrates, the conductive paste layer 14 does not necessarily include the second conductive filler 141b. The conductive paste layer 14 may only include, as the conductive filler 141, the first conductive filler 141a whose particles have a crushed shape.

### Third Embodiment

FIG. 6 is a partial sectional view illustrating the outline configuration of a solid electrolytic capacitor 10B according to a third embodiment. The solid electrolytic capacitor 10B differs from the solid electrolytic capacitors 10 and 10A according to the above embodiments only in the shape of particles of a conductive filler 141 included in a conductive paste layer 14. FIG. 6 illustrates, while enlarging, the conductive paste layer 14 and the vicinity thereof in the solid electrolytic capacitor 10B.

Referring to FIG. 6, the conductive filler 141 includes a first conductive filler 141c and a second conductive filler 141b. In the example illustrated in FIG. 6, the conductive filler 141 is constituted by the first conductive filler 141c and the second conductive filler 141b.

The second conductive filler 141b has a configuration similar to that of the second conductive filler 141b used in the solid electrolytic capacitor 10A according to the second embodiment. On the other hand, the first conductive filler 141c differs from the first conductive filler 141a used in the solid electrolytic capacitor 10A according to the second embodiment.

Particles of the first conductive filler 141c each have a flat shape. The particles of the first conductive filler 141c each have, for example, a plate shape. Unlike the first conductive filler 141a of the second embodiment, a surface of a particle of the first conductive filler 141c of the present embodiment has no fracture surface. A particle of the first conductive filler 141c preferably has no sharp edge in a sectional view of the solid electrolytic capacitor 10B. A particle of the first conductive filler 141c may have a sharp edge, but each particle of the first conductive filler 141c has four or less sharp edges.

In a sectional view of the solid electrolytic capacitor 10B, the first conductive filler 141c have an aspect ratio of 4.5 or more. The aspect ratio of the second conductive filler 141b is less than 4.0 as in the second embodiment. The aspect ratio of each of the first conductive filler 141c and the second conductive filler 141b can be obtained by dividing the length of the major axis of a particle thereof by the length of the minor axis of the particle thereof.

The length of the major axis, the length of the minor axis, and the aspect ratio of each of the first conductive filler 141c and the second conductive filler 141b can be obtained by the method described in the second embodiment by using a sectional SEM image of the solid electrolytic capacitor 10B.

The particle diameters of the first conductive filler 141c and the second conductive filler 141b are the lengths of the major axes of particles of the first conductive filler 141c and the second conductive filler 141b. The average particle diameter of the first conductive filler 141c can be obtained by averaging the particle diameters of the particles of the first conductive filler 141c included in a sectional SEM image of the solid electrolytic capacitor 10B. Similarly, the average particle diameter of the second conductive filler 141b can be obtained by averaging the particle diameters of the particles of the second conductive filler 141b included in the sectional SEM image. The average particle diameter of the first conductive filler 141c is 0.5 times or more and less than 2.0 times the maximum layer thickness of the conductive paste layer 14 obtained from the same sectional SEM image. The average particle diameter of the second conductive filler 141b is 0.1 times or more and less than 0.5 times the maximum layer thickness of the conductive paste layer 14. The average particle diameter of the second conductive filler 141b is smaller than the average particle diameter of the first conductive filler 141c. The average particle diameter of the second conductive filler 141b is, for example, 50% or less of the average particle diameter of the first conductive filler 141c, preferably 40% or less.

The main component of the core material of the first conductive filler 141c may be the same as or different from the main component of the core material of the second conductive filler 141b. In addition, in the conductive paste layer 14, the core material of the entire first conductive filler 141c may be mainly constituted by the same component, or the first conductive fillers 141c whose core materials differ in main component may exist in a mixed manner. Similarly, in the conductive paste layer 14, the core material of the entire second conductive filler 141b may be mainly constituted by the same component, or the second conductive fillers 141b whose core materials differ in main component may exist in a mixed manner.

Since having a configuration similar to the configuration of the solid electrolytic capacitor 10 according to the first embodiment, the solid electrolytic capacitor 10B according to the present embodiment can also exhibit the same advantageous effects as those of the solid electrolytic capacitor 10 according to the first embodiment. In addition, in the solid electrolytic capacitor 10B according to the present embodiment, the first conductive filler 141c whose particles have a flat shape is included in the conductive paste layer 14. The particles of the first conductive filler 141c have a relatively smooth surface with less or no sharp edges. Thus, a crack starting from a sharp edge of the conductive filler can be suppressed from occurring in the conductive paste layer 14. Accordingly, the mechanical strength of the conductive paste layer 14 as well as the solid electrolytic capacitor 10B can be improved.

In the present embodiment, the conductive paste layer 14 includes the second conductive filler 141b in addition to the first conductive filler 141c. Since the second conductive filler 141b has an average particle diameter smaller than that of the first conductive filler 141c, particles of the second conductive filler 141b can enter spaces between particles of the first conductive filler 141c. Thus, a continuous current path is easily formed in the layer thickness direction of the conductive paste layer 14, and resistance of the conductive paste layer 14 can be reduced.

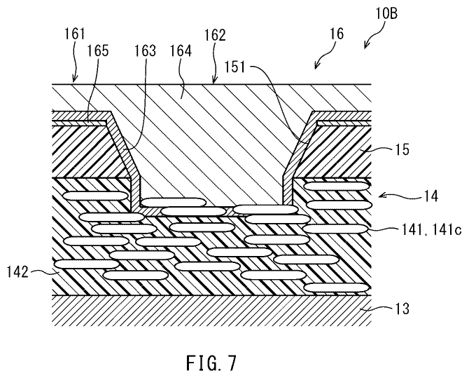

In the example illustrated in FIG. 6, the conductive paste layer 14 includes the first conductive filler 141c and the second conductive filler 141b. However, as FIG. 7 illustrates, the conductive paste layer 14 does not necessarily include the second conductive filler 141b. For example, the conductive paste layer 14 may only include, as the conductive filler 141, the first conductive filler 141c whose particles have a flat shape.

Although the embodiments according to the present disclosure have so far been described, the present disclosure is not limited to the above-described embodiments, and various modifications can be made without departing from the spirit of the present disclosure.

A solid electrolytic capacitor according to the present disclosure is as follows.
<1> A solid electrolytic capacitor, including: a valve metal base having first surface and a second surface opposite to each other in a thickness direction of the valve metal base; a first dielectric layer on the first surface of the valve metal base; a second dielectric layer on the second surface of the valve metal base; a first conductive paste layer on the first dielectric layer and including a first conductive filler; a second conductive paste layer on the second dielectric layer and including a second conductive filler; a first insulating layer on the first conductive paste layer and having a first via hole; a second insulating layer on the second conductive paste layer and having a second via hole; a first outer electrode layer on the first insulating layer and electrically connected to the first conductive paste layer through the first via hole, wherein the first outer electrode layer is in direct contact with a portion of the first conductive filler in the first conductive paste layer in the first via hole when viewed in a first lamination direction of the first conductive paste layer, the first insulating layer, and the first outer electrode layer; and a second outer electrode layer on the second insulating layer and electrically connected to the second conductive paste layer through the second via hole, wherein the second outer electrode layer is in direct contact with a portion of the second conductive filler in the second conductive paste layer in the second via hole when viewed in a second lamination direction of the second conductive paste layer, the second insulating layer, and the second outer electrode layer.
<2> The solid electrolytic capacitor according to the item <1>, in which the outer electrode layers include an outer electrode layer body formed on a surface of the insulating layers on a side opposite from the conductive paste layers, and the conductive paste layers includes, as a main conductive filler, a filler having a core material including, as a main component, the same metal as a main component of the outer electrode layer body.
<3> The solid electrolytic capacitor according to the item <2>, in which the main component of the outer electrode layer body is copper, and the main conductive filler is a filler whose core material includes copper as a main component.
<4> The solid electrolytic capacitor according to the item <2>, in which the outer electrode layers further include a via conductor in the via holes, and a main component of the via conductor is the same metal as the main component of the core material of the main conductive filler.
<5> The solid electrolytic capacitor according to the item <4>, in which the main component of the outer electrode layer body and the main component of the via conductors are copper, and the main conductive filler is a filler whose core material includes copper as a main component.
<6> The solid electrolytic capacitor according to any one of the items <1> to <5>, in which, in a sectional view of the solid electrolytic capacitor, a filling rate of the conductive filler relative to a length of the conductive paste layers in the lamination direction is 50% or more.
<7> The solid electrolytic capacitor according to any one of the items <1> to <6>, in which the conductive fillers include first conductive particles having a crushed shape.
<8> The solid electrolytic capacitor according to any one of the items <1> to <6>, in which the conductive fillers includes first conductive particles having a flat shape.
<9> The solid electrolytic capacitor according to the item <7> or <8>, in which the conductive fillers further include a second conductive particle having an average particle diameter smaller than an average particle diameter of the first conductive particle.

### EXAMPLES

To confirm the difference in advantageous effects due to the shape of particles of the conductive filler 141, the solid electrolytic capacitors 10A and 10B illustrated in FIG. 3, FIG. 5, FIG. 6, and FIG. 7 were actually produced, and equivalent series resistances (ESRs) were measured. In addition, from each of the sectional SEM images of the solid electrolytic capacitors 10A and 10B, the filling rate of the conductive filler 141 in the layer thickness direction of the conductive paste layer 14 (the lamination direction of the conductive paste layer 14, the insulating layer 15, and the outer electrode layer 16) was measured. More specifically, a sectional SEM image of each of the solid electrolytic capacitors 10A and 10B illustrated in FIG. 3, FIG. 5, FIG. 6, and FIG. 7 was obtained, and required image processing was performed thereon. Subsequently, in the sectional SEM image, at each of 10 spots spaced uniformly in a direction orthogonal to the layer thickness direction, the sum S_{L1} of the lengths L1 of the particles of the conductive filler 141 in the layer thickness direction was measured, and the filling rate (%) of the conductive filler 141 was obtained by dividing the sum S_{L1} by the layer thickness L0 of the conductive paste layer 14. By averaging the filling rates, the filling rate (%) of the conductive filler 141 in the conductive paste layer 14 in the layer thickness direction was obtained on each of the solid electrolytic capacitors 10A and 10B. The results of the measurement are given in Table 1.

TABLE 1

| | | Filling | ESR (Ratio | |
|---|---|---|---|---|
| EXAMPLES | Filler shape | rate [%] | to EXAMPLE 1) | Remarks |
| 1 | Crushed shape | 57.3 | 1.0 | FIG. 5 |
| 2 | Crushed shape + | 58.5 | 0.9 | FIG. 3 |
| | Small diameter | | | |
| 3 | Flat shape | 61.2 | 1.5 | FIG. 7 |
| 4 | Flat shape + | 66.8 | 0.7 | FIG. 6 |
| | Small diameter | | | |

In each of Examples 1 to 4, the filling rate of the conductive filler 141 in the lamination direction is 50% or more, which can prove that the conductive paste layer 14 is sufficiently filled with the conductive filler 141 in the layer thick direction of the conductive paste layer 14. In each of Examples 1 to 4, the ESR was reduced by about 10% compared with a general chip-type electrolytic capacitor. The ESR was further reduced in Example 2 (FIG. 3) and Example 4 (FIG. 6) in which the second conductive filler 141b having a small diameter was added, compared with Example 1 (FIG. 5) using only the first conductive filler 141a whose particles have a crushed shape and Example 3 (FIG. 7) using only the first conductive filler 141c whose particles have a flat shape.

### REFERENCE SIGNS LIST

10, 10A, 10B solid electrolytic capacitor
11 valve metal base
113 dielectric layer
14 conductive paste layer
141 conductive filler
141a, 141c first conductive filler
141b second conductive filler
15 insulating layer
151 via hole
16 outer electrode layer
161 outer electrode layer body
162 via conductor

1. A solid electrolytic capacitor, comprising:
a valve metal base having first surface and a second surface opposite to each other in a thickness direction of the valve metal base;
a first dielectric layer on the first surface of the valve metal base;
a first conductive paste layer on the first dielectric layer and including a first conductive filler;
a first insulating layer on the first conductive paste layer and having a first via hole; and
a first outer electrode layer on the first insulating layer and electrically connected to the first conductive paste layer through the first via hole, wherein the first outer electrode layer is in direct contact with a portion of the first conductive filler in the first conductive paste layer in the first via hole when viewed in a first lamination direction of the first conductive paste layer, the first insulating layer, and the first outer electrode layer.

2. The solid electrolytic capacitor according to claim 1, further comprising:
a second dielectric layer on the second surface of the valve metal base;
a second conductive paste layer on the second dielectric layer and including a second conductive filler;
a second insulating layer on the second conductive paste layer and having a second via hole; and
a second outer electrode layer on the second insulating layer and electrically connected to the second conductive paste layer through the second via hole, wherein the second outer electrode layer is in direct contact with a portion of the second conductive filler in the second conductive paste layer in the second via hole when viewed in a second lamination direction of the second conductive paste layer, the second insulating layer, and the second outer electrode layer.

3. The solid electrolytic capacitor according to claim 1, wherein
the first outer electrode layer includes a first outer electrode layer body on a surface of the first insulating layer on a side thereof opposite from the first conductive paste layer, and
the first conductive filler of the first conductive paste layer includes, a first filler having a first core material including, as a main component thereof, a same metal as a main component of the first outer electrode layer body.

4. The solid electrolytic capacitor according to claim 3, wherein
the main component of the first outer electrode layer body is copper, and
the first core material of the first filler includes copper as a main component.

5. The solid electrolytic capacitor according to claim 3,
wherein the first outer electrode layer further includes a first via conductor in the first via hole, and
a main component of the first via conductor is a same metal as the main component of the first core material of the first filler.

6. The solid electrolytic capacitor according to claim 5, wherein
the main component of the first outer electrode layer body and the main components of the first via conductor are copper, and
the first core material of the first filler includes copper as a main component.

7. The solid electrolytic capacitor according to claim 2, wherein
the first outer electrode layer includes a first outer electrode layer body on a surface of the first insulating layer on a side thereof opposite from the first conductive paste layer,
the first conductive filler of the first conductive paste layer includes, a first filler having a first core material including, as a main component thereof, a same metal as a main component of the first outer electrode layer body,
the second outer electrode layer includes a second outer electrode layer body on a surface of the second insulating layer on a side thereof opposite from the second conductive paste layer, and
the second conductive filler of the second conductive paste layer includes, a second filler having a second core material including, as a main component thereof, a same metal as a main component of the second outer electrode layer body.

8. The solid electrolytic capacitor according to claim 7, wherein
the main component of the first outer electrode layer body is copper,
the first core material of the first filler includes copper as a main component,
the main component of the second outer electrode layer body is copper, and
the second core material of the second filler includes copper as a main component.

9. The solid electrolytic capacitor according to claim 7, wherein
the first outer electrode layer further includes a first via conductor in the first via hole,
a main component of the first via conductor is a same metal as the main component of the first core material of the first filler,
the second outer electrode layer further includes a second via conductor in the second via hole, and
a main component of the second via conductor is a same metal as the main component of the second core material of the second filler.

10. The solid electrolytic capacitor according to claim 9, wherein
the main component of the first outer electrode layer body and the main component of the first via conductor are copper, and
the first core material includes copper as a main component,
the main component of the second outer electrode layer body and the main component of the second via conductor are copper, and
the second core material includes copper as a main component.

11. The solid electrolytic capacitor according to claim 2, wherein
the second outer electrode layer includes a second outer electrode layer body on a surface of the second insulating layer on a side thereof opposite from the second conductive paste layer, and
the second conductive filler of the second conductive paste layer includes, a second filler having a core material including, as a main component thereof, a same metal as a main component of the second outer electrode layer body.

12. The solid electrolytic capacitor according to claim 11, wherein
the main component of the second outer electrode layer body is copper, and
the core material of the second filler includes copper as a main component.

13. The solid electrolytic capacitor according to claim 11, wherein
the second outer electrode layer further includes a second via conductor in the second via hole, and
a main component of the second via conductor is a same metal as the main component of the core material of the second filler.

14. The solid electrolytic capacitor according to claim 13, wherein
the main component of the second outer electrode layer body and the main component of the second via conductor are copper, and
the core material includes copper as a main component.

15. The solid electrolytic capacitor according to claim 1, wherein, in a sectional view of the solid electrolytic capacitor, a first filling rate of the first conductive filler relative to a length of the first conductive paste layer in the lamination direction is 50% or more.

16. The solid electrolytic capacitor according to claim 2, wherein,
in a sectional view of the solid electrolytic capacitor, a first filling rate of the first conductive filler relative to a length of the first conductive paste layer in the lamination direction is 50% or more, and
in the sectional view of the solid electrolytic capacitor, a second filling rate of the second conductive filler relative to a length of the second conductive paste layer in the lamination direction is 50% or more.

17. The solid electrolytic capacitor according to claim 2, wherein at least one of the first conductive filler and the second conductive filler include first conductive particles having a crushed shape.

18. The solid electrolytic capacitor according to claim 17, wherein the at least one of the first conductive filler and the second conductive filler further includes second conductive particles having an average particle diameter smaller than an average particle diameter of the first conductive particles.

19. The solid electrolytic capacitor according to claim 2, wherein at least one of the first conductive filler and the second conductive filler include first conductive particles having a flat shape.

20. The solid electrolytic capacitor according to claim 19, wherein the at least one of the first conductive filler and the second conductive filler further includes second conductive particles having an average particle diameter smaller than an average particle diameter of the first conductive particles.
